(19) United States
(12) Patent Application Publication
(10) Pub. No.: US 2011/0203612 A1
(43) Pub. Date: Aug. 25, 2011

(54) DEVICE FOR PROCESSING PRODUCTS SUCH AS FRUIT OR VEGETABLES WITH A CLEANING CARRIAGE WITH HYDRAULIC DRIVE AND CLEANING METHOD

(75) Inventor: Philippe BLANC, Montauban (FR)

(73) Assignee: MAF AGROBOTIC, Montauban (FR)

(21) Appl. No.: 13/035,011

(22) Filed: Feb. 25, 2011

(30) Foreign Application Priority Data
Feb. 25, 2010 (FR) 10.00779

(51) Int. Cl. B08B 1/00; B08B 3/00

(52) U.S. Cl. 134/6; 134/133

(57) ABSTRACT

A device for processing products such as fruit or vegetables includes at least one hydraulic channel (11) for transporting the products, and elements for producing a liquid flow in each hydraulic channel, at least one cleaning carriage (20) carrying guiding members (19), members (30, 32) for brushing the walls of each cleaned channel, and at least one hydraulic drive blade (34) capable of extending in the liquid flow flowing in at least one cleaned channel (11) in order to drive the cleaning carriage (20) in translation in each cleaned channel (11) under the effect of this liquid flow.

The invention relates to a device for processing products such as fruit and vegetables comprising at least one hydraulic channel for transporting products, each channel extending between side walls, and means capable of producing a liquid flow parallel to the side walls in each hydraulic channel. In general, it aims to solve the problem of cleaning each hydraulic channel of such a device, and covers a method for cleaning such a device.

Such a processing device is, for example, but not exclusively, a unit for sorting fruit or vegetables according to predetermined selection criteria, comprising a device for continuous supply with products, at least one station for analysing predetermined characteristics of the products (for example by weighing, calibrating, optical analysis, etc.), and a device capable of discharging the products upstream of a plurality of parallel hydraulic channels according to the result of the analysis of the products, so as to group the products in batches having the same characteristics with regard to said selection criteria in each hydraulic channel. The products thus grouped in each hydraulic channel can then be extracted from each hydraulic channel and packed. U.S. Pat. No. 7,159,373 describes the general design of one example of such a processing device.

Such a processing device poses the general problem of the cleaning of the walls of each hydraulic channel, which has to be carried out regularly.

Until now, this cleaning has been essentially carried out manually by sweeping and/or brushing (with or without suction/filtration) of the walls by a human operator during phases when the device is stopped, for example at night. Such a cleaning operation, although it is long, complex and costly, is preferred to the addition of an automatic cleaning robot which may prohibitively increase the cost price and the use and maintenance costs of such a processing device. Moreover, it necessitates interruption of the device, which is undesirable in certain applications for which the device preferably has to be able to operate continuously.

Furthermore, it should be noted that there is usually provision for continuous filtration of the flow of the liquid flowing in the hydraulic channels. This filtration is generally partial, in view of the large volume of liquid with which the hydraulic channels are supplied. With such a partial filtration, the impurities present in the liquid flow may happen to be recycled in the hydraulic channels, which they may soil again. Nevertheless, such a filtration makes it possible to clarify the liquid flowing in the channels, such that the walls and any soiling present thereon on the other hand become perfectly visible. Consequently, it is all the more desirable to clean the walls on a very regular basis.

The invention therefore aims to solve these problems by proposing a processing device equipped with at least one automatic cleaning device capable of cleaning regularly—especially as often as possible—the walls of each hydraulic channel in which it is driven to move, and which moreover is sufficiently simple and inexpensive to be compatible with operation on an industrial scale, especially on a unit for sorting fruit or vegetables, and in particular is competitive compared with manual cleaning of each hydraulic channel.

The invention also aims to propose a method for cleaning such a processing device, this method having the same features, especially being able to be automated.

The invention therefore relates to a device for processing products such as fruit or vegetables comprising:
at least one hydraulic channel for transporting the products, each channel extending between side walls,
means for producing a liquid flow parallel to the side walls in each hydraulic channel,
   wherein it comprises at least one cleaning carriage carrying:
brushing members for brushing walls of at least one hydraulic channel, called the cleaned channel,
at least one hydraulic drive blade capable of extending in the liquid flow flowing in at least one cleaned channel in order to drive the cleaning carriage in translation in each cleaned channel under the effect of this liquid flow.

Advantageously, in a device according to the invention, each cleaning carriage can be driven to move downstream in each cleaned channel solely hydraulically, that is to say by the flow of the liquid flowing in at least one cleaned channel. Consequently, the means used for this drive are simplified in the extreme, and have only very low impact on the manufacturing and use costs of the device.

In particular, advantageously and according to the invention, at least one hydraulic drive blade is a plane plate extending transversely relative to a cleaned channel. Preferably, advantageously and according to the invention, the plate extends, allowing for clearances, over the transverse cross-section of the cleaned channel. The plate carried by the cleaning carriage is thus adapted to obstruct the liquid flow flowing in a cleaned channel, so as to be driven downstream by this liquid flow, substantially at the same speed as the latter, and to drive the cleaning carriage in the same way.

As the cleaning carriage moves downstream, the brushing members in contact with the walls of each cleaned channel have the effect of cleaning these walls.

In a device according to the invention, the same cleaning carriage can enable a plurality of parallel hydraulic channels to be treated simultaneously, by straddling these channels and being driven downstream by the liquid flow flowing in at least one of them.

Nevertheless, preferably, advantageously and according to the invention, a cleaning carriage is adapted to surmount and clean a single cleaned channel. In this embodiment, the cleaning carriage can be equipped with a simple single plate extending transversely in the cleaned channel surmounted by the cleaning carriage guided by guiding members such as rollers rolling on the side walls of the cleaned channel.

Furthermore, a processing device according to the invention can have a plurality of cleaning carriages, for example one cleaning carriage dedicated to each hydraulic channel. Nevertheless, preferably, advantageously, a processing device according to the invention comprises a plurality of parallel hydraulic channels and is characterized in that it comprises a device for transferring the cleaning carriage from one hydraulic channel to the other. Thus, it is not necessary to provide a cleaning carriage for each hydraulic channel. In particular, a processing device according to the invention can comprise a single cleaning carriage, the transfer device enabling this cleaning carriage to be transferred from one hydraulic channel to the other, the different hydraulic channels being cleaned successively by this same cleaning carriage.

Furthermore, advantageously and according to the invention, the cleaning carriage carries side brushing members capable of coming into contact with the side walls of each cleaned channel, and bottom brushing members capable of coming into contact with a bottom wall of each cleaned channel. In this way, all the walls delimiting the same cleaned channel are cleaned by brushing. Preferably, the cleaning carriage comprises, for each wall, two successive brushing members, one upstream and the other downstream.

Advantageously and according to the invention, the brushing members are arranged and mounted relative to the cleaning carriage so as to be applied with an elastic compressive stress against the walls to be cleaned. For example, each brushing member is mounted on a flexible elastic strip.

Furthermore, after being moved downstream in each cleaned channel under the effect of a liquid flow, a cleaning carriage of a device according to the invention has to be able also to be returned to its initial position upstream of each cleaned channel for the next cleaning operation. To do this, various variant embodiments can be envisaged. For example, in one possible variant of the invention, the cleaning carriage can be simply transported manually by an operator who replaces it at the upstream end of each cleaned channel.

In a preferred variant, advantageously and according to the invention, the cleaning carriage comprises a motorized device and carries members for guiding the cleaning carriage in translation along each cleaned channel, the motorized device and said guiding members being arranged to be able to place the cleaning carriage in either of the following positions:
in a cleaning position in each cleaned channel, in which cleaning position the brushing members are in contact with the walls to be cleaned, and each hydraulic drive blade can be driven by a liquid flow of a cleaned channel,
in a return position, in which it is disposed above each cleaned channel without cooperating with the liquid flow flowing in each cleaned channel, each hydraulic drive blade being out of the liquid flow and the brushing members not being in contact with the walls to be cleaned.

In the cleaning position, the guiding members enable free movement of the cleaning carriage along each cleaned channel.

It should be noted that in one possible variant embodiment, the brushing members at least partly act as guiding members. In another variant embodiment, specific guiding members, distinct from the brushing members, for example rollers, are provided.

In a preferred embodiment, the guiding members are formed by rollers arranged to roll on free upper edges of side walls. In the return position, the cleaning carriage is advantageously raised relative to the cleaning position so as to extend entirely above the liquid flow flowing in each cleaned channel. For example, the guiding rollers are mounted at the end of arms articulated relative to the cleaning carriage, the articulated arms being moved by the said motorized device.

In addition, advantageously and according to the invention, the motorized device comprises at least one actuator—especially a pneumatic or hydraulic cylinder or an electric motor—carried by the cleaning carriage and supplied with energy—especially with fluid under pressure or electricity—by a line—especially a tube or a cable—wound on a drum carried upstream of each cleaned channel, said drum being free to rotate in the direction of unwinding of the line and of movement of the cleaning carriage downstream in each cleaned channel and coupled to a motor capable of winding the line on the drum and moving the cleaning carriage upstream by traction on the line.

Thus, the supply line of the actuator of the cleaning carriage has a dual function and is used to act not only as an energy supply for the actuator, but also as a traction cable for returning the cleaning carriage to its initial upstream position.

It should be noted that a processing device according to the invention can have any other motorized device for driving the cleaning carriage into its initial upstream position, especially a specific traction cable driven by a drum or the like.

Advantageously, a device according to the invention is a device for sorting and grouping batches of products, equipped with at least one sorting unit disposed upstream of each hydraulic channel and adapted to discharge into each hydraulic channel products sorted according to predetermined selection criteria. The invention may, however, have other applications for other types of processing devices.

The invention also covers a cleaning method implemented in a device according to the invention. The invention therefore also relates to a method for cleaning a device for processing products such as fruit or vegetables in which a cleaning device is driven to move in at least one hydraulic channel of this device, wherein at least one cleaning carriage is placed in at least one hydraulic channel, called the cleaned channel, said cleaning carriage being guided in translation along at least one side wall of a cleaned channel, and being equipped with members for brushing the walls of each cleaned channel, and with at least one hydraulic drive blade immersed in the liquid flow flowing in at least one cleaned channel, the cleaning carriage being driven in translational movement under the effect of this liquid flow.

In a method according to the invention, after a cleaning carriage has been placed in the cleaning position upstream of at least one hydraulic channel, the cleaning carriage is allowed to move freely under the effect of the liquid flow flowing in at least one cleaned channel which exerts a pressure downstream on each hydraulic drive blade.

In a method according to the invention, a cleaning carriage can be placed in a hydraulic channel after the hydraulic channel has been emptied, or when the hydraulic channel is not being supplied with products. Nevertheless, a significant advantage of a method according to the invention is to enable the cleaning of a hydraulic channel even when the device for processing the products is in operation. Thus, advantageously and according to the invention, a cleaning carriage is placed in a hydraulic channel after the latter has received a predetermined quantity of products corresponding to a batch.

The invention thus enables the automatic cleaning of each hydraulic channel in operation, in an extremely simple, inexpensive manner, and even without manual intervention of human operators.

The invention also relates to a device and a method characterized in combination by some or all of the features mentioned above or below.

Other objects, features and advantages of the invention will become apparent on reading the following description which is given without limitation and refers to the accompanying figures in which:

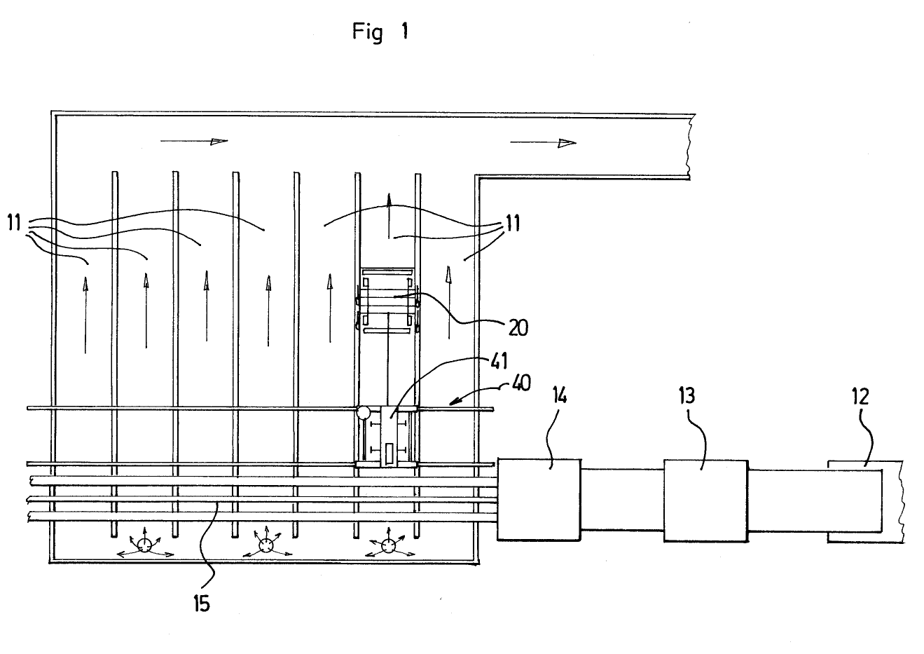

FIG. 1 is a general diagram in plan of a processing device according to a first embodiment of the invention,

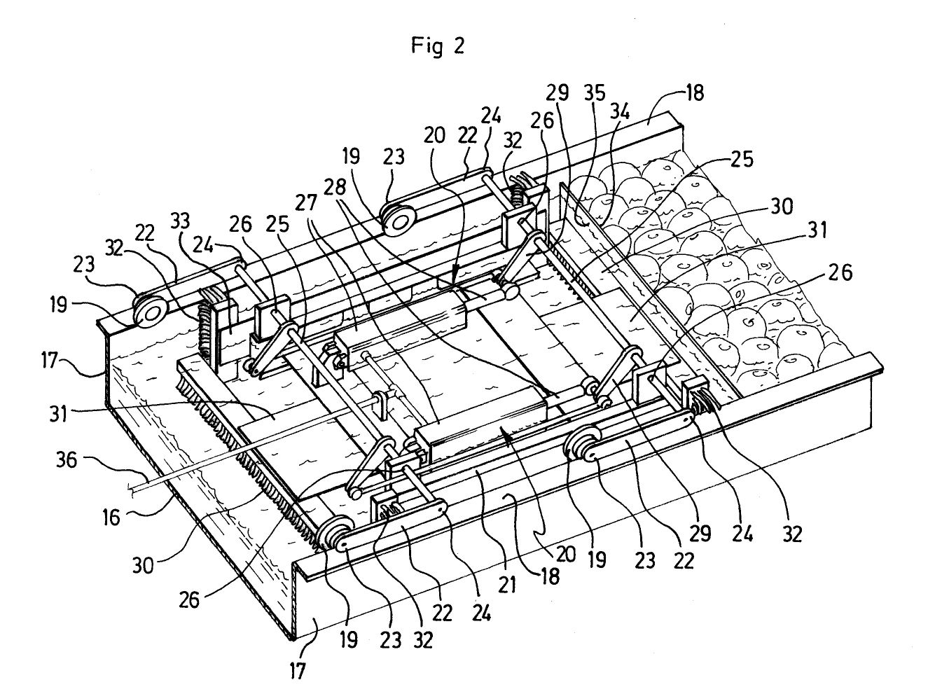

FIG. 2 is a diagram in perspective of a cleaning carriage of a processing device according to the first embodiment of the invention,

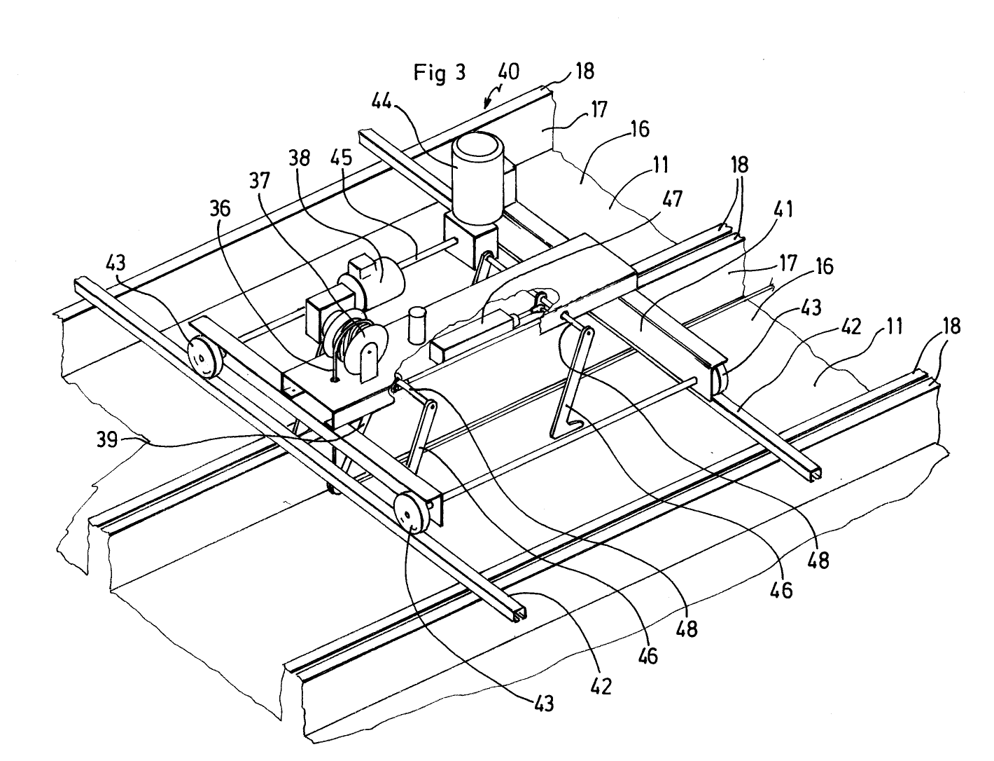

FIG. 3 is a diagram in perspective of a transfer carriage of a processing device according to the first embodiment of the invention,

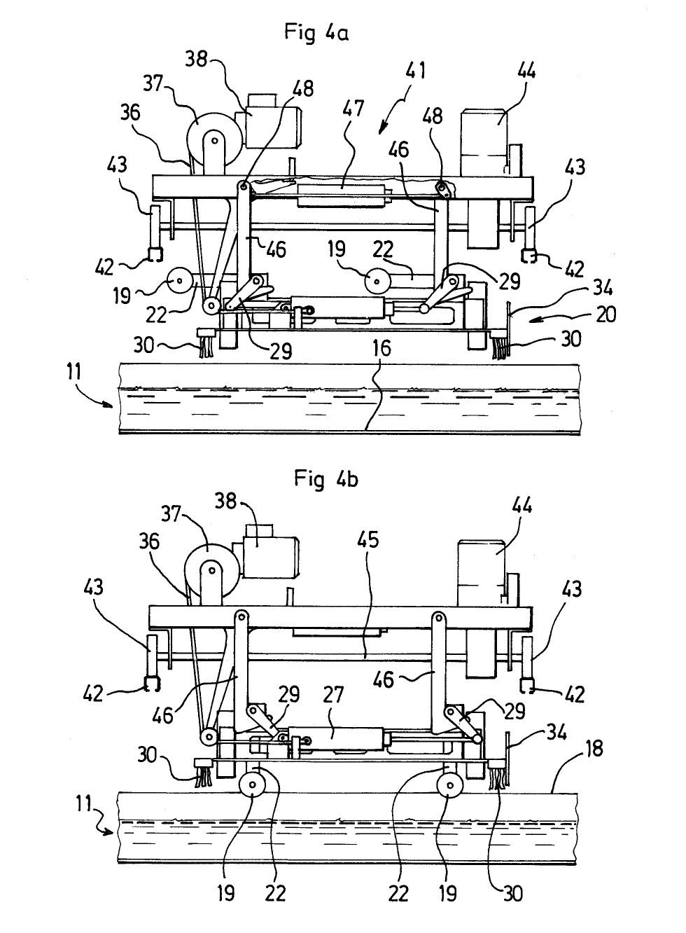

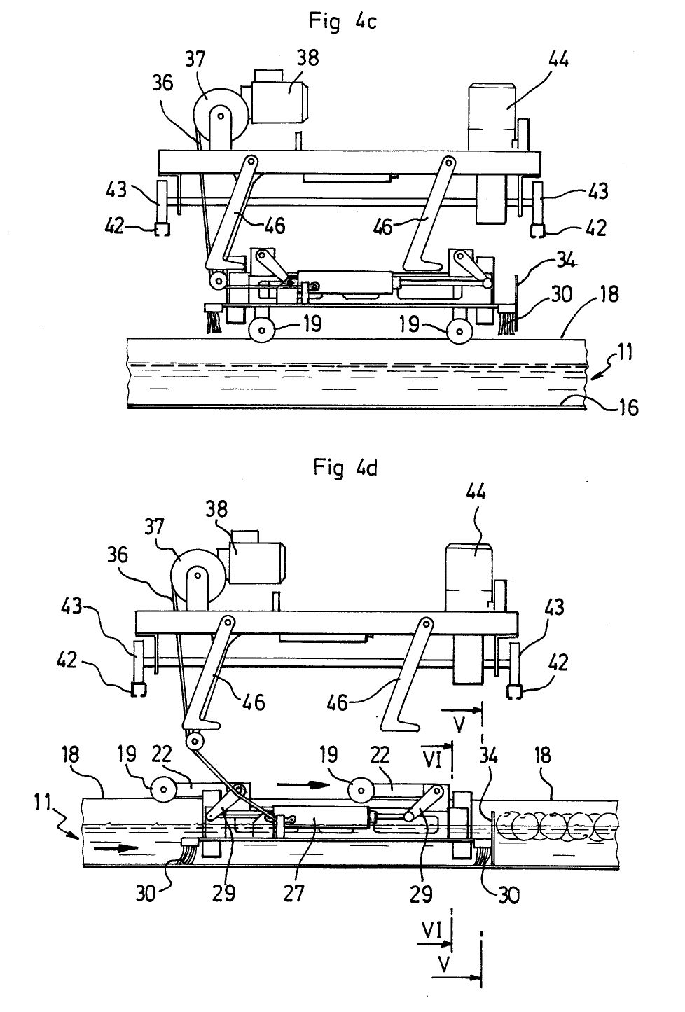

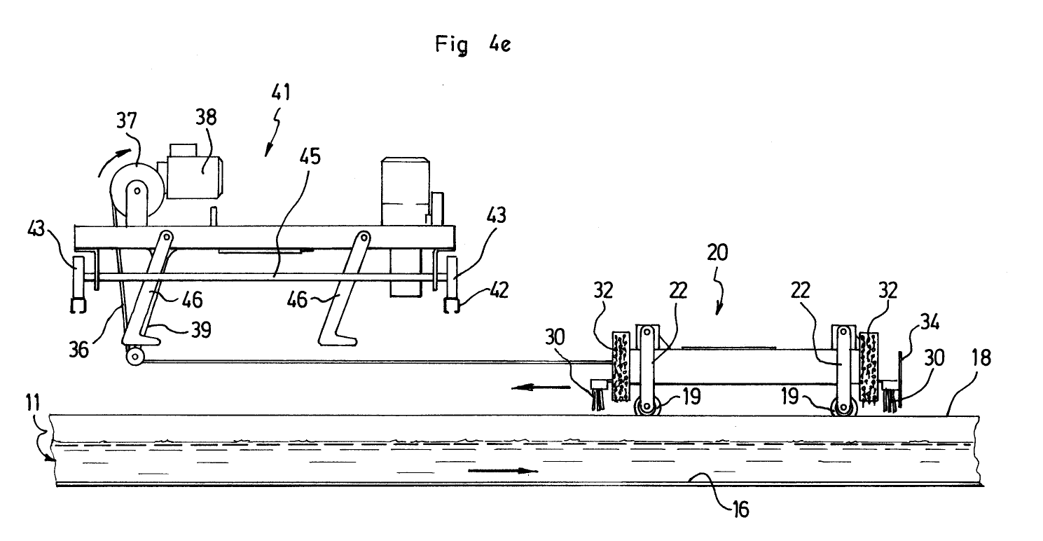

FIGS. 4a to 4e are diagrams in section on a longitudinal vertical plane of a hydraulic channel showing a processing device according to the first embodiment of the invention in various stages of a cleaning method according to the invention,

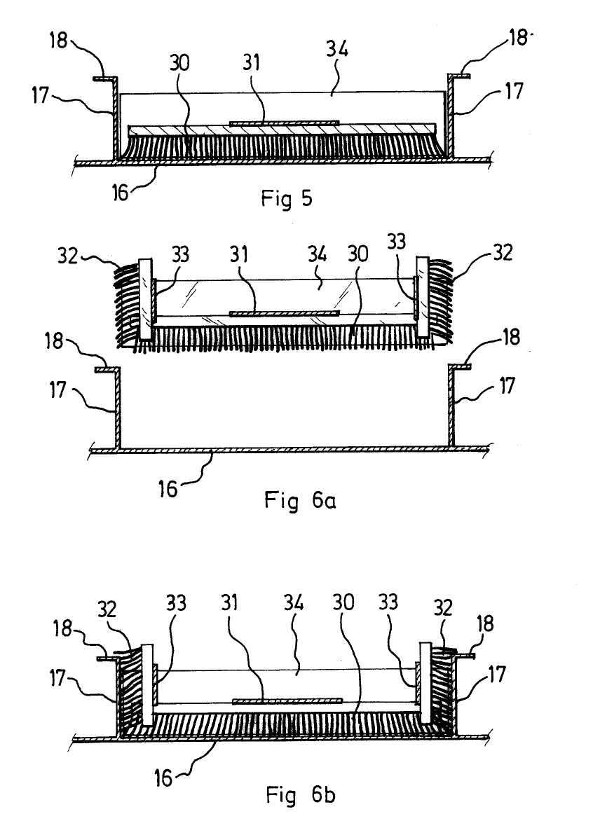

FIG. 5 is a diagram in section along the line V-V of FIG. 4d,

FIGS. 6a and 6b are diagrams in section along the line VI-VI of FIG. 4d, the cleaning carriage being in the return position and in the cleaning position respectively,

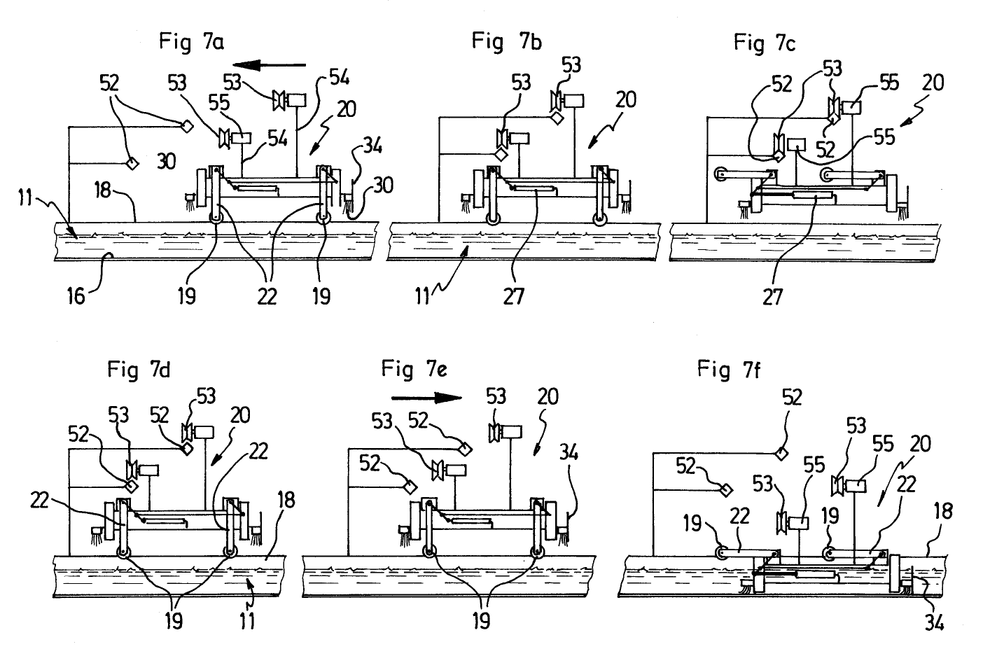

FIGS. 7a to 7f are diagrams in section on a longitudinal vertical plane of a hydraulic channel showing a processing device according to a second embodiment of the invention in various stages of a cleaning method according to the invention.

A processing device according to the invention as shown in the figures is a unit for automatic sorting of fruit or vegetables according to predetermined selection criteria making it possible to group the products into batches which can then be processed, in particular packed and/or packaged, in a homogeneous manner compatible with their subsequent use.

Such a device comprises, in a manner known per se (cf. for example U.S. Pat. No. 7,159,373), a plurality of hydraulic channels 11 parallel to and adjoining one another, which are each supplied with a liquid flow produced by a pumping station (not shown) and recycled in a closed cycle. At least partial and continuous filtration of the liquid is generally provided.

The automatic sorting unit comprises a inlet receptacle for bulk products, a supply conveyor drawing the products from the inlet receptacle, at least one station 13, 14 for analysis of the products according to predetermined selection criteria—especially, in the example shown, a weighing station 13 and a station 14 for optical analysis—, a sorting conveyor 15 capable of discharging the products after analysis upstream (relative to the direction of flow of the liquid) of one of the hydraulic channels 11, according to the results of the analysis performed.

In general, the liquid is water and the products float in the liquid. The invention is nevertheless applicable to any other liquid, and to products transported by a liquid flow without necessarily floating relative to the liquid.

The hydraulic channels 11 are each formed of a bottom 16 in the shape of a generally horizontal longitudinal strip (preferably with a slight slope downstream to facilitate the flow of the liquid) and side walls 17 extending upwards on each side the bottom. The side walls 17 have a free upper edge 18 which is horizontal or parallel to the bottom and forms a rolling path for rollers 19 of a cleaning carriage 20.

The cleaning carriage 20 comprises a chassis 21, in the general shape of a frame, of a width corresponding to that of a hydraulic channel 11 so that it can surmount and straddle the latter, rolling on the upper edges 18 of the two side walls 17 of the hydraulic channel, called the cleaned channel 11, surmounted by the carriage 20, by means of the rollers 19 mounted freely rotatably about horizontal transverse axes relative to the chassis 21.

The rollers 19 are mounted relative to the chassis 21 by means of raising arms 22 articulated relative to the chassis about horizontal transverse axes. In the embodiment shown, each roller 19 is mounted freely rotatably at the end 23 of an arm 22 whose other end 24 is rotationally fixed to a horizontal transverse shaft 25 mounted rotatably relative to the chassis 21 by means of two bearings 26. The shaft 25 is rotationally driven and held in angular position by means of at least one double-acting cylinder 27 mounted on the chassis 21 and whose actuating rod 28 is articulated to a link 29 rotationally fixed to the shaft 25.

The arms 22 coupled to the same shaft 25, at each of its ends, are parallel to each other and can be placed either in the cleaning position in which the arms 22 are at least substantially horizontal so that the chassis 21 is lowered into the cleaned channel 11 or in the raised position, called the return position, in which the arms 22 are at least substantially vertical so that the chassis 21 is raised above the cleaned channel 11.

The carriage 20 comprises two parallel transverse shafts 25 each carrying two articulated arms 22 and two rollers 19, which are positionally controlled by two synchronized cylinders 27 (supplied in parallel by the same source of fluid pressure) or by a single cylinder. Preferably, the rollers 19 are of the shoulder type so as to block the carriage 20 laterally relative to the side walls 17.

The carriage 20 also comprises brushing members 30, 32 for brushing the walls 16, 17 of the cleaned channel 11. In the embodiment shown, the carriage 20 carries a pair of bottom brushes 30 and two pairs of side brushes 32.

The bottom brushes 30 are arranged to rub on the bottom 16 of the cleaned channel 11 when the carriage 20 is in the cleaning position. The two bottom brushes 30 are respectively fastened to the ends of an elastic strip 31 fastened by its middle portion on the chassis 21, the assembly being adapted so that the elastic strip 31 is deformed in elastic deflection when the carriage 20 is in the cleaning position, the bottom brushes 30 being applied with elastic stress against the bottom 16.

The side brushes 32 are arranged to rub on the side walls 17 of the cleaned channel 11 when the carriage 20 is in the cleaning position. The two side brushes 32 of the same pair are respectively fastened to the ends of an elastic strip 33 fastened by its middle portion on the chassis 21, the assembly being adapted so that the elastic strip 33 is deformed in elastic deflection when the carriage 20 is in the cleaning position, the side brushes 32 being applied with elastic stress against the corresponding facing side wall 17.

The carriage 20 also carries a hydraulic drive plate 34 whose dimensions correspond as closely as possible (allowing for clearances) to those of the transverse cross-section of the cleaned channel 11. The hydraulic drive plate 34 extends transversely and is mounted relative to chassis 21 so as to obstruct, in the cleaning position, the flow of the liquid flowing in the cleaned channel 11. Consequently, in the cleaning position, the plate 34 receives on its upstream face 35 the pressure induced by the liquid flow in the cleaned channel 11, which has the effect of driving it, and the carriage 20 to which it is fixed, so as to move downstream in the cleaned channel 11.

In the embodiment shown, the hydraulic drive plate 34 is mounted at the downstream end of the carriage 20, so as also to form a barrier to the products that may be located downstream of the carriage 20, which are transported by the liquid flow in the cleaned channel 11. In this way, there is no risk of the carriage 20 interfering with these products. In a variant, it is nevertheless possible to provide for mounting a hydraulic drive plate rather at the upstream end of the carriage 20, which promotes the efficiency of the hydraulic drive by the liquid flow. It is nevertheless possible also to provide two hydraulic drive plates, one downstream and the other upstream.

Each hydraulic drive plate is mounted relative to chassis 21 so as to extend in the liquid flow in the cleaning position for the hydraulic drive of the carriage 20, and so as to be located entirely outside the liquid flow in the return position, so as no longer to interfere with the latter, in order to allow the return of the carriage 20 towards the upstream end of the cleaned channel 11.

The cylinders 27 carried by the chassis 21 are supplied with fluid under pressure, for example compressed air in the case of pneumatic cylinders, by means of a flexible tube 36 which is wound on a drum 37 disposed upstream of the cleaned channel 11 and is automatically unwound during the cleaning phase as the carriage 20 moves downstream, and rewound during the return phase of the carriage 20 to the upstream end. The drum 37 is coupled to a motor 38 which enables its rotational driving in one direction or the other. At the exit of the drum 37, a tension sensor 39 enables detection of the tension of the tube 36. When the tension in the tube 36 is sufficient, as detected by the sensor 39, the motor 38 is controlled in the direction of unwinding the tube 36, so that the latter follows the movement of the carriage 20 downstream in the cleaning phase.

When the tension in the tube 36 as detected by the sensor 39 is below a predetermined threshold, this means that the carriage 20 has reached the downstream end of the cleaned channel 11. In this situation, the cylinders 27 are supplied with fluid under pressure so as to place the carriage 20 in the return position, then the motor 38 is controlled so as to wind the tube 26 on the drum 37. Thus, the tube 26 draws along the carriage 20 in an upstream movement, the rollers 19 rolling on the side walls 17. In the return position (FIG. 4e), no member of the carriage 20 interferes with the liquid flow, and in particular the brushes 30, 32 are located above the liquid flow (FIG. 6a). Preferably, the length of the arms 22 is such that the carriage 20 is even located entirely above the upper edges 18 of the side walls 17. In this way, the carriage 20 offers no particular resistance to its upstream movement under the effect of the traction by the tube 26.

It should be noted further that the fact that the carriage 20 is located entirely outside the cleaned channel 11 in the return position makes it possible, in this position, to use the cleaned channel 11 to receive new products without the risk of interfering with the cleaning carriage 20. In other words, the operations of cleaning and return of the carriage 20 can be integrated into the general operation of the processing device according to the invention without disturbing any of the phases thereof and without reducing the performance or productivity thereof.

A transfer device 40 is also provided for automatically moving the cleaning carriage 20 from one hydraulic channel 11 to the other, so that the management of the cleaning of a processing device according to the invention can be fully automated.

In the example shown, this transfer device 40 comprises a transfer carriage 41 guided and driven on rails 42 extending above the upstream ends of the hydraulic channels 11, perpendicularly to the hydraulic channels 11. The rails 42 are parallel to the sorting conveyor 15, and can extend upstream or below or immediately downstream of the latter. It is sufficient to ensure that the transfer device 40 does not interfere with the operation of the sorting conveyor 15 and vice versa that the sorting conveyor 15 does not interfere with the operation of the transfer device 40. In the example shown, the rails 42 of the transfer device 40 extend immediately downstream of the sorting conveyor 15.

The transfer carriage 41 carries the drum 37 for winding the tube 36 and the motor 38 driving this drum 37. The drum 37 is itself supplied with fluid under pressure by a flexible pipe (not shown) which follows the movements of the transfer carriage 41 on the rails 42 and is connected to the tube 36.

The transfer carriage 41 also carries rollers 43, preferably of the shoulder type, enabling the guidance and movement of the transfer carriage 41 on the rails 42. The carriage 41 also carries a motor 44 for driving this transfer carriage 41 on the rails 42, this motor 44 being rotationally coupled to a shaft 45 fixed to a pair of rollers 43.

The transfer carriage 41 also carries hooks 46 hanging from the transfer carriage 41, each hook 46 being articulated at its upper end to the transfer carriage 41 about an axis generally orthogonal to the longitudinal direction of the hydraulic channels 11. The lower end of the hooks 46 is adapted to hook onto the cleaning carriage 20, under a transverse bar of the latter, for example under the shafts 25 of the arms 22 carrying the rollers 19.

The transfer carriage 41 advantageously comprises two pairs of hooks 46, each pair of hooks 46 being fixed to the same shaft 48 and adapted to hook under one of the shafts 25 of the cleaning carriage 20 when the latter is in the return position and is driven in an upstream movement until it comes under the transfer carriage 41. A double-acting cylinder 47 carried by the transfer carriage 41 enables the rotational driving of the shaft 48 and movement of each pair of hooks 46 between a hooking position where the hooks 46 are located under the shaft 25 and a release position in which the cleaning carriage 20 is no longer suspended from the hooks 46 and vice versa. The transfer carriage 41 may comprise a single cylinder 47 controlling (via an appropriate mechanism) the two pairs of hooks 46. In a variant not shown, the transfer carriage 41 comprises two cylinders 47 supplied in parallel, one cylinder 47 for each pair of hooks 46, so that the hooks 46 are controlled in a synchronized manner.

The rails 42 are arranged at a sufficient height above the hydraulic channels to allow the passage of the cleaning carriage 20 under the rails 42 and thus under the transfer carriage 41.

When the hooks 46 are positioned under the shafts 25 of the cleaning carriage 20, the cylinders 27 can be actuated to replace the arms 22 into the cleaning position. However, the carriage 20 then remains suspended from the hooks 46 above the hydraulic channel 11 and does not redescend into cleaning position in the hydraulic channel 11 (FIG. 4a). The motor 44 for driving the transfer carriage 41 is then controlled to move the latter above another hydraulic channel 11 to be cleaned. When the appropriate position is obtained, the cylinders 27 are again actuated to replace the rollers 19 into contact with the edges 18 of the side walls 17 of the hydraulic channel 11 which is to be cleaned (FIG. 4b). The cylinder(s) 47 for controlling the hooks 46 is(are) actuated into the release position (FIG. 4c), then the cylinders 27 are again actuated to place the arms 22 and the rollers 19 in the cleaning position (FIG. 4d). The cleaning carriage 20 thus released is then driven downstream by the liquid flow and performs the cleaning of the hydraulic channel 11.

The device according to the invention also incorporates appropriate control logic which can be installed wholly or partly on the cleaning carriage 20 and/or on the transfer carriage 41 and/or incorporated in a fixed control unit. The control logic receives signals emitted by various sensors detecting the position and/or the travel of the cleaning carriage 20, the position and/or the travel of the transfer carriage 41, the state and/or the travel of the various motors and cylinders. The control logic is adapted and programmed to emit signals enabling control of the appropriate movements of the various motors and cylinders. FIGS. 7a to 7f show a second embodiment of a processing device according to the invention in various stages of a cleaning method according to the invention. This second embodiment differs from the first in that the transfer device is not formed by a second carriage, but by motorized rollers 53 carried by the cleaning carriage 20 itself and cooperating with rails 52 extending above the upstream ends of the hydraulic channels 11, perpendicularly to the hydraulic channels 11. The rails 52 are parallel to the sorting conveyor 15, and may extend upstream or below or immediately downstream of the latter. The rails 52 are similar to the rails 42 of the first embodiment, except that they are offset along the vertical direction relative to each other, that is to say at different heights, so as to be able to be engaged laterally by pairs of rollers 53 of the carriage 20, also offset with respect to each other in the vertical direction. Each roller 53 of the carriage 20 is carried at the upper end of a support 54 which also carries a motor 55 for driving the roller 53. Preferably, the cleaning carriage 20 comprises four rollers 53, that is to say, two pairs of rollers 53, each pair cooperating with one of the rails 52.

In this second embodiment, the cleaning carriage 20 can be completely independent, equipped for example with a rechargeable accumulator battery, all the actuators that it includes being in the form of electric motors supplied with low-voltage current by this accumulator battery. The cleaning carriage 20 may also incorporate an electronic circuit forming a unit for controlling its operation automatically or by remote control, for example by radiofrequency, Wifi, etc. This control unit may be in particular adapted to monitor the charge of the accumulator battery and control a movement of the cleaning carriage 20 on the rails 52 to a location where it is automatically connected to an electrical circuit for recharging the accumulator battery.

FIG. 7a shows a method step in which the cleaning carriage 20 is returning to the rails 52 in the return position.

FIG. 7b shows a method step in which the cleaning carriage 20 arrives in a position in which the rollers 53 are above the rails 52, the arms 22 and the rollers 19 still being in the return position.

FIG. 7c shows a method step in which the cleaning carriage 20 is suspended from the rails 52 by the rollers 53 from the position of FIG. 7b, by actuating the actuator 27 placing the rollers 19 and the arms 22 in the cleaning position in a position in which the rollers 19 are at a distance from the edges 18. In this position, the cleaning carriage 20 can be moved along the rails 52 by actuating the motors 55 for driving the rollers 53, until it is above a new hydraulic channel 11 to be cleaned.

FIG. 7d shows a method step in which the cleaning carriage 20 arrives above the new hydraulic channel 11 to be cleaned, and the actuator 27 is actuated to replace the arms 22 and the rollers 19 in the return position, the rollers 19 coming to rest again on the edges 18, simultaneously releasing the rollers 53 from the rails 52 owing to the fact that the carriage 20 undergoes a slight upward movement.

From the position of FIG. 7d, the cleaning carriage 20 is moved laterally downstream as shown in FIG. 7e over a sufficient distance to free it from the rails 52 and allow its descent into the cleaning position in the channel 11. To do this, the rollers 19 can be coupled to low-power electric drive motors. These electric motors for driving the rollers 19 can also be used to drive the carriage 20 in the return position in the direction shown in FIG. 7a.

FIG. 7f shows the cleaning carriage 20 in the cleaning position in the hydraulic channel 11. In this position, the cleaning carriage 20 is driven downstream by the liquid flow exerting a pressure on the hydraulic drive plate 34.

The invention may have many variant embodiments with respect to the embodiments shown in the figures and described above. In particular, the hydraulic drive blade formed by the plate 34 may be replaced by a blade having a different shape and/or provided with openings allowing the passage of the liquid, or by a plurality of vanes or other members for the hydraulic drive of the cleaning carriage 20.

In the embodiments shown and described, the processing device according to the invention comprises a single cleaning carriage adapted to clean only one hydraulic channel. In a variant, it is nevertheless possible to provide for the same processing device according to the invention to include a plurality of cleaning carriages and/or a plurality of transfer devices.

Likewise, the same cleaning carriage may in a variant be provided to clean simultaneously in parallel a plurality of hydraulic channels, while being driven hydraulically downstream by the liquid flow of one of these hydraulic channels or all the hydraulic channels. To do so it is sufficient to provide a plurality of chassis, each chassis being equipped with brushing members and running through a single hydraulic channel, the different chassis being connected to one another to be driven and controlled simultaneously.

In addition, the hydraulic drive blade may be mounted pivotally relative to the cleaning carriage between a cleaning position where it extends vertically as shown in the figures, a stop preventing its pivoting downstream beyond this position, and a position turned down horizontally upstream in which it interferes substantially no longer with the liquid flow in the channel, so that the driving of the cleaning carriage upstream is made possible by simple traction on a cable wound on a drum. The end of said cable can be coupled to the lower edge of the drive blade so as to control its movement in the position turned down upstream. In this variant, the cleaning carriage can be completely free of any actuator.

Other brushing members than simple fixed brushes or brooms can be provided, for example rotating brushes, scrapers, etc.

The various motors and cylinders can be selected from actuators of all types: electrical, electromagnetic, hydraulic, pneumatic, etc.

Debris detached from the walls of the hydraulic channel by brushing by the cleaning carriage can be extracted from the liquid flowing in the cleaned channel by any centralized filtration system and/or by suction/filtration by a device carried by the cleaning carriage or any other system for solid/liquid extraction.

1. A device for processing products such as fruits or vegetables, said device comprising:
at least one hydraulic channel for transporting the products, each channel extending between side walls,
means for producing a liquid flow parallel to said side walls in each of said at least one hydraulic channel,
wherein it comprises at least one cleaning carriage carrying:
brushing members for brushing walls to be cleaned of at least one of said at least one hydraulic channel, named at least one cleaned channel,
at least one hydraulic drive blade suited to be capable of extending in a liquid flow flowing in at least one of said at least one cleaned channel so as to drive said cleaning carriage in translation along each of said at least one cleaned channel under the effect of said liquid flow.

2. A device as claimed in claim 1, wherein at least one hydraulic drive blade is a plane plate extending transversely relative to a cleaned channel.

3. A device as claimed in claim 2, wherein said plate extends, allowing for clearances, over the transverse cross-section of said cleaned channel.

4. A device as claimed in claim 1, wherein one of said at least one cleaning carriage is adapted to surmount and clean a single cleaned channel.

5. A device as claimed in claim 4, comprising a plurality of hydraulic channels, wherein it comprises a device for transferring said cleaning carriage from one hydraulic channel to the other.

6. A device as claimed in claim 1, wherein said cleaning carriage carries side brushing members configured for coming into contact with the side walls of each of said at least one cleaned channel, and bottom brushing members configured for coming into contact with a bottom wall of each of said at least one cleaned channel.

7. A device as claimed in claim 1, wherein said brushing members are arranged and mounted relative to said cleaning carriage so as to be applied with an elastic compressive stress against said walls to be cleaned.

8. A device as claimed in claim 1, wherein said cleaning carriage comprises a motorized device and carries guiding members for guiding said cleaning carriage in translation along each of said at least one cleaned channel, said motorized device and said guiding members being arranged to be able to place said cleaning carriage:
in a cleaning position in each cleaned channel, in which cleaning position said brushing members are in contact with said walls to be cleaned, and each of said at least one hydraulic drive blade extends in said liquid flow so as to be driven by said liquid flow,
in a return position, in which said cleaning carriage is disposed above each of said at least one cleaned channel without cooperating with each liquid flow flowing in each of said at least one cleaned channel, each of said at least one hydraulic drive blade is out of the liquid flow, and the brushing members are not in contact with said walls to be cleaned.

9. A device as claimed in claim 8, wherein said motorized device comprises at least one actuator carried by said cleaning carriage and supplied with energy by a line wound on a drum carried upstream of each of said at least one cleaned channel, said drum being free to rotate in a direction of unwinding of said line and of movement of said cleaning carriage downstream in each of said at least one cleaned channel, said drum being coupled to a motor capable of winding said line on said drum and of moving said cleaning carriage upstream by traction on said line.

10. A device as claimed in one of claim 1, wherein it is a device for sorting and grouping batches of products, and is equipped with at least one sorting unit disposed upstream of each of said at least one hydraulic channel and adapted to discharge into each hydraulic channel products sorted according to predetermined selection criteria.

11. Method for cleaning a device for processing products such as fruit or vegetables, in which a cleaning device is driven to move in at least one hydraulic channel of said device, wherein at least one cleaning carriage is placed in at least one hydraulic channel, named at least one cleaned channel, said cleaning carriage being guided in translation along at least one side wall of at least one of said at least one cleaned channel, and being equipped with brushing members for brushing the walls of each of said at least one cleaned channel, and with at least one hydraulic drive blade immersed in a liquid flow flowing in at least one of said at least one cleaned channel, said cleaning carriage being driven in translational movement under the effect of said liquid flow.

12. Method as claimed in claim 11, wherein a cleaning carriage is placed in a hydraulic channel after the latter has received a predetermined quantity of products corresponding to a batch.
